(19) United States
(12) Patent Application Publication
(10) Pub. No.: US 2025/0242614 A1
(43) Pub. Date: Jul. 31, 2025

(54) PRINTER

(71) Applicant: BROTHER KOGYO KABUSHIKI KAISHA, Nagoya (JP)

(72) Inventor: Narumi TODA, Nagoya (JP)

(21) Appl. No.: 19/041,447

(22) Filed: Jan. 30, 2025

(30) Foreign Application Priority Data
Jan. 31, 2024 (JP) 2024-012865

(51) Int. Cl. B41J 15/04; B41J 11/70

(52) U.S. Cl. CPC B41J 15/042; B41J 11/706; B41J 15/044

(57) ABSTRACT

A printer includes a cassette compartment accommodating a cassette, a print head printing on a medium housed in a cassette case, a cradle, a cutter blade, and a cutter holder. The cradle is disposed downstream of the print head in a transport direction of the medium and supports the medium. The cutter blade includes a cutting edge facing the cradle in a facing direction. The cutter holder includes a specific wall disposed upstream of the cutter blade in the transport direction. An end of the specific wall in a second facing direction is disposed to the second facing direction of a virtual straight line. The second facing direction is opposite to a first facing direction in the facing direction. The virtual straight line is a line connecting the cutting edge and an end, in the first facing direction, of a discharge port that discharges the medium form the cassette case.

### REFERENCE TO RELATED APPLICATIONS

This application claims priority from Japanese Patent Application No. 2024-012865 filed on Jan. 31, 2024. The entire content of the priority application is incorporated herein by reference.

### BACKGROUND ART

The present disclosure relates to a printer.

Conventionally, printers having a cutting mechanism for cutting a printed medium are known. For example, a conventional tape printer is provided with a cutter blade holding member, a guide holder, and a cutter blade. The cutter blade holding member supports a medium. The guide holder supports the cutter blade such that the cutter blade can be moved between a retracted position and a cutting position. The cutter blade cuts the medium between the cutter blade and the cutter blade holding member by moving from the retracted position to the cutting position.

### SUMMARY

In the tape printer described above, the cutter blade may return from the cutting position to the retracted position with a tip end of the medium cut by the cutter blade stuck to the cutting edge of the cutter blade. If printing starts with the tip end of the medium stuck to the cutting edge of the cutter blade, a jam may occur.

The present disclosure aims to provide a printer that contributes to reducing the occurrence of jams.

A printer according to one aspect of the present disclosure uses a cassette provided with a medium and a cassette case configured to house the medium. The printer is provided with a cassette compartment, a transport roller, a print head, a cradle, a cutter blade, and a cutter holder. The cassette compartment is configured such that the cassette is removably installed therein. The transport roller is configured to transport the medium. The print head is configured to print on the medium. The cradle disposed downstream of the print head in a transport direction of the medium, and configured to support the medium. The cutter blade is a plate on which is formed a cutting edge extending in an intersecting direction intersecting the transport direction. The cutting edge faces the cradle in a facing direction intersecting the transport direction and the intersecting direction. The cutter holder holds the cutter blade and is configured to move the cutter blade between a retracted position and a cutting position. The cutting edge is separated from the cradle in the facing direction when the cutter blade is positioned at the retracted position. The cutting edge sandwiches the medium with the cradle and cuts the medium when the cutter blade is positioned at the cutting position. The cutter holder includes a specific wall disposed upstream of the cutter blade in the transport direction. In a state in which the cassette is installed in the cassette compartment and the cutter blade is disposed at the retracted position, when a virtual straight line is defined that connects the cutting edge and an end, in a first facing direction from the cradle toward the cutter blade, in the facing direction, of a discharge port, which is an opening formed at a downstream end of the cassette case in the transport direction, through which the medium is discharged from the cassette case, an end of the specific wall in a second facing direction opposite the first facing direction, in the facing direction, is disposed to the second facing direction of the virtual straight line.

According to this aspect, the printer contributes to reducing the occurrence of jams.

### BRIEF DESCRIPTION OF DRAWINGS

FIG. 1 is a perspective view of a printer and a cassette.

FIG. 2 is a perspective view of the cassette.

FIG. 3 is a plan view of a front portion of an upper wall when the cassette is not installed in a cassette compartment.

FIG. 4 is a perspective view of a print mechanism, a transport mechanism, and a cutting mechanism when a holder unit is mounted to a cutter mounting portion.

FIG. 5 is a perspective view of the print mechanism, the transport mechanism, and the cutting mechanism when the holder unit is mounted to the cutter mounting portion.

FIG. 6 is a perspective view of the holder unit.

FIG. 7 is a back view of the holder unit.

FIG. 8 is a perspective view of the print mechanism, the transport mechanism, and the cutting mechanism when the holder unit is not mounted to the cutter mounting portion.

FIG. 9 is a cross-sectional view from above of an area around the cutting mechanism when a cutter blade is positioned at a retracted position.

FIG. 10 is a cross-sectional view from above of the area around the cutting mechanism when the cutter blade is positioned at a cutting position.

FIG. 11 is a plan view of the front portion of the upper wall when the cassette is installed in the cassette compartment.

FIG. 12 is a view illustrating the positional relationship of a protrusion.

### DESCRIPTION

A printer 1 and a cassette 100 according to one embodiment of the present disclosure will be described with reference to the drawings. Note that the drawings are used to illustrate technical features that the present disclosure may employ. In other words, the configuration and the like illustrated in the drawings are not intended to be limited thereto, but are merely illustrative examples.

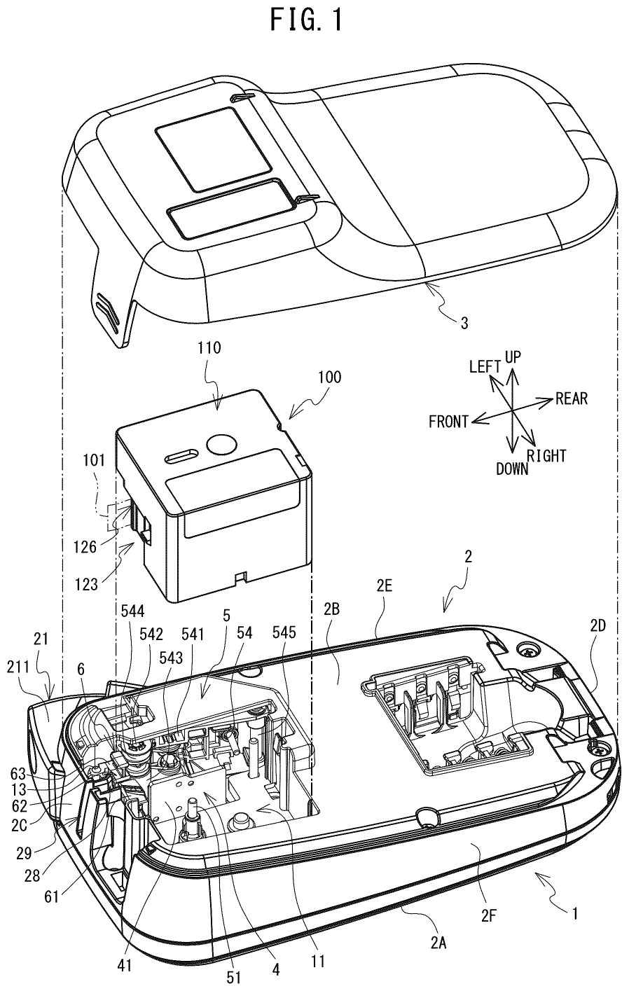

Hereinafter, the direction of lower left, upper right, upper left, lower right, down, and up in FIG. 1 refer respectively to the directions of front, rear, left, right, down, and up with respect to the printer 1 and the cassette 100. In the present embodiment, a side surface facing a specific direction will be referred to as a “surface in a specific direction.” For example, a rear surface of a member is the side surface of the member facing rearward. The surface in a specific direction need not necessarily extend orthogonal to the specific direction, so long as it extends so as to intersect the specific direction. Similarly, “a member extending in a first direction and a second direction that are orthogonal to each other” need not necessarily extend orthogonal to a third direction that is orthogonal to the first direction and the second direction, so long as the member extends so as to intersect the third direction.

The printer 1 shown in FIG. 1 is a device that uses the cassette 100 and prints on a tape 101. In the present embodiment, the printer 1 is a mobile thermal printer. The tape 101 is a type of print medium, and in the present embodiment, is formed by a base material, a double-sided adhesive layer, and a release paper laminated together.

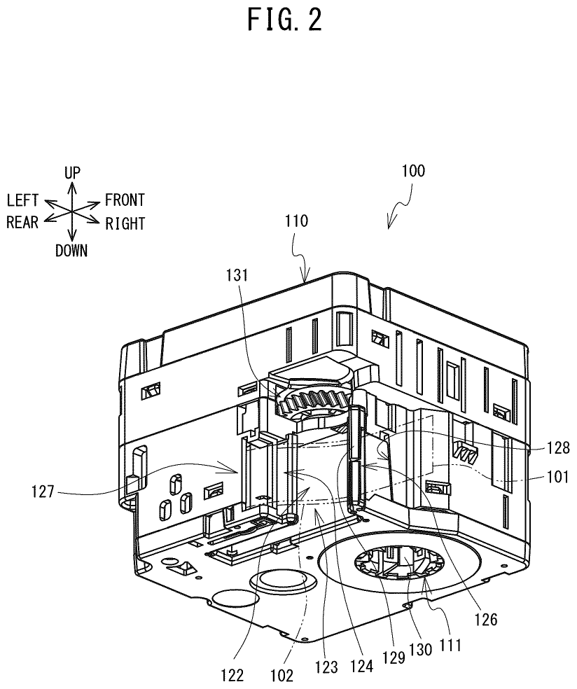

The overall configuration of the cassette 100 will be described with reference to FIG. 1 and FIG. 2. The cassette 100 is provided with a cassette case 110, the tape 101, and an ink ribbon 102 (refer to FIG. 2). The cassette case 110 has a cuboid box shape.

A recessed portion 123 is formed on a left surface of the cassette case 110. The recessed portion 123 is recessed toward the right from a left front lower portion of the cassette case 110 and further recessed to the rear. The recessed portion 123 is open to below from a lower surface of the cassette case 110. Hereinafter, an opening formed in the left surface of the cassette case 110 by the recessed portion 123 will be referred to as an “exposed portion 122”, and a portion of the cassette case 110 that is to the left of the recessed portion 123 will be referred to as an “arm portion 127” (refer to FIG. 2).

As shown in FIG. 2, a guide port 124 for guiding the tape 101 and the ink ribbon 102 to the exposed portion 122 from within the arm portion 127 is formed in a front end of the arm portion 127. In other words, the exposed portion 122 is an opening for exposing the tape 101 and the ink ribbon 102 from the cassette case 110 between the guide port 124 and a discharge port 126, described later. The guide port 124 has a slit shape and extends in the up-down direction.

A guide 129 is provided on a left front lower corner portion of the cassette case 110. The guide 129 has a pillar shape and extends in the up-down direction. The discharge port 126 is formed in the guide 129 to eject the tape 101 out of the cassette case 110. The discharge port 126 has a slit shape and extends in the up-down direction. The discharge port 126 is a region surrounded by a front end of the guide 129. The discharge port 126 is disposed on a downstream end of a transport path of the tape 101 in the cassette 100. In other words, the tape 101 does not contact the cassette 100 after passing through the discharge port 126.

An entrance 128 that allows the ink ribbon 102 to enter the cassette case 110 from the exposed portion 122 is formed to the right of the discharge port 126 in the recessed portion 123. The entrance 128 has a slit shape and extends in the up-down direction.

A support hole 111 is formed in the lower surface of the cassette case 110. The support hole 111 rotatably supports a ribbon winding spool 130. The ribbon winding spool 130 is housed in the cassette case 110. The ribbon winding spool 130 has a cylindrical shape and extends in the up-down direction. An input gear (not shown in the drawings) is fixed to an upper end of the ribbon winding spool 130. An output gear 131 is connected to the input gear via a connecting gear (not shown in the drawings) rotatably supported by the cassette case 110. The output gear 131 is disposed above the exposed portion 122 and is rotatably supported by the cassette case 110. The output gear 131 is exposed to the left from the left of the cassette case 110.

A ribbon roll (not shown in the drawings) and a tape roll (not shown in the drawings) are also housed in the cassette case 110. The ribbon roll is formed by the ink ribbon 102 wound around the ribbon spool. The ink ribbon 102 stretches between the ribbon roll and the ribbon winding spool 130 via the exposed portion 122. The tape roll is formed by the tape 101 wound around the tape spool.

With the cassette 100, the ink ribbon 102 is pulled off of the ribbon roll by the ribbon winding spool 130 rotating. After being pulled off of the ribbon roll, the ink ribbon 102 passes through the exposed portion 122 via the guide port 124. The ink ribbon 102 is exposed at the exposed portion 122 from the cassette case 110. After passing through the exposed portion 122, the ink ribbon 102 enters the cassette case 110 via the entrance 128. After entering the cassette case 110, the ink ribbon 102 is taken up by the ribbon winding spool 130.

When the tape 101 is transported by the transport mechanism 5, described later, the tape 101 is pulled off of the tape roll. After being pulled out from the tape roll, the tape 101 passes through the exposed portion 122 via the guide port 124. The tape 101 is exposed from the cassette case 110 at the exposed portion 122 and overlaid with the ink ribbon 102 from the left. After passing through the exposed portion 122, the ink ribbon 102 is discharged from the cassette case 110 through the discharge port 126.

The configuration of the printer 1 will now be described with reference to FIG. 1. The printer 1 is provided with a housing 2, a lid 3, the print mechanism 4, the transport mechanism 5, and the cutting mechanism 6. The housing 2 has a cuboid shape and includes a lower wall 2A, an upper wall 2B, a front wall 2C, a rear wall 2D, a left wall 2E, and a right wall 2F. The lower wall 2A is disposed at a lower end of the housing 2 and extends in the front-rear direction and the left-right direction. A display (not shown in the drawings) and operation buttons (not shown in the drawings) are provided on the lower wall 2A.

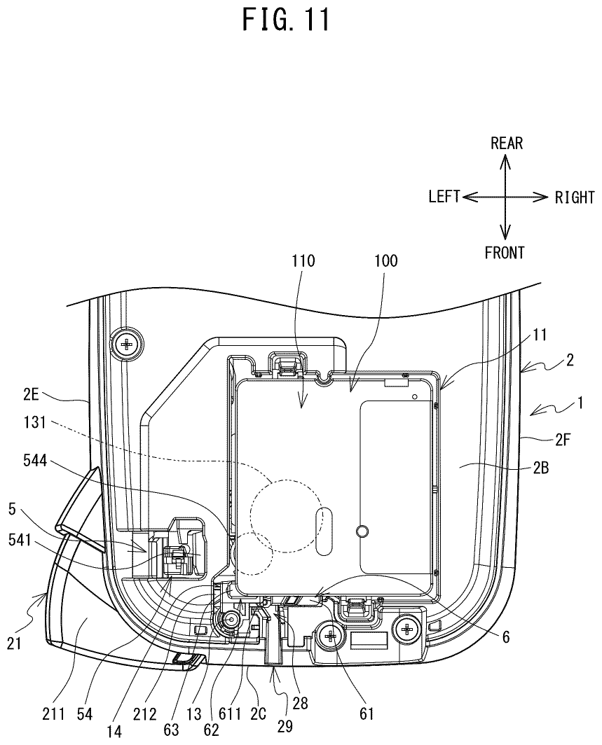

The upper wall 2B is disposed at an upper end of the housing 2 and extends in the front-rear direction and the left-right direction. A cassette compartment 11 and a discharge path 28 are provided at a front portion of the upper wall 2B. The cassette compartment 11 is a recessed portion that is recessed downward from the upper wall 2B. The cassette compartment 11 has a shape corresponding to the external shape of the cassette 100 in a plan view (refer to FIG. 11). The cassette 100 is removably installed in the up-down direction in the cassette compartment 11. The discharge path 28 is connected to a left front portion of the cassette compartment 11 and extends from the cassette compartment 11 forward to the front wall 2C. The discharge path 28 is a recessed portion that is recessed downward from the upper wall 2B. The discharge path 28 defines the transport path of the tape 101 discharged from the discharge port 126.

The front wall 2C is disposed at a front end of the housing 2 and extends from a front end of the lower wall 2A to a front end of the upper wall 2B. The front wall 2C is provided with a discharge port 29 for discharging the printed tape 101 from within the housing 2. The discharge port 29 has a slit shape and extends in the up-down direction. The discharge port 29 is a front end of the discharge path 28. The rear wall 2D is disposed at a rear end of the housing 2 and extends from a rear end of the lower wall 2A to a rear end of the upper wall 2B. The left wall 2E is disposed at a left end of the housing 2 and extends from a left end of the lower wall 2A to a left end of the upper wall 2B. The right wall 2F is disposed at a right end of the housing 2 and extends from a right end of the lower wall 2A to a right end of the upper wall 2B.

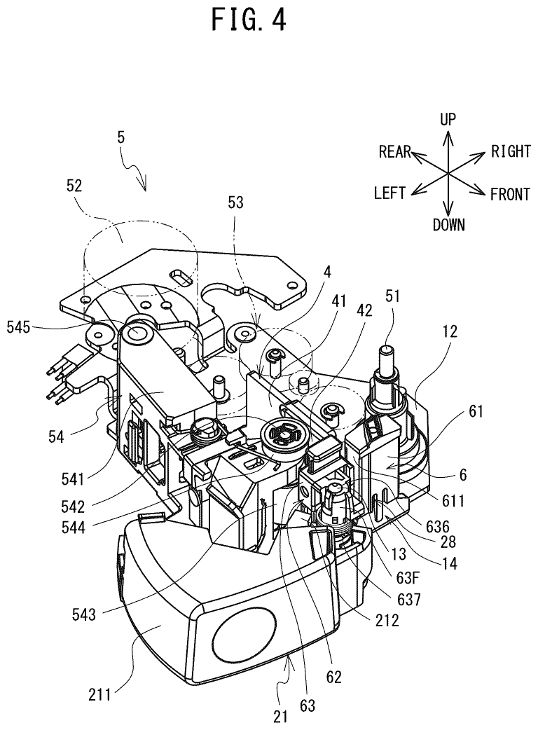

A cutting lever 21 is provided at a left front corner portion of the housing 2. The cutting lever 21 has a triangular shape in plan view and is rotatably supported about a cutter mounting shaft 13. The cutter mounting shaft 13 is disposed in front of a cutter holder 63, described later. The cutter mounting shaft 13 is fixed to a support plate 12, described later, and extends upward from the support plate 12. The cutting lever 21 includes an operation portion 211 and a contact portion 212 shown in FIG. 4. The operation portion 211 is a portion protruding to the left from the left wall 2E. The contact portion 212 is disposed on the left of the cutter holder 63, described later, in the housing 2.

The lid 3 shown in FIG. 1 has a plate shape and extends in the front-rear direction and the left-right direction. The lid 3 is attached to the housing 2 from above. In a state in which the lid 3 is attached to the housing 2, the lid 3 covers the cassette compartment 11 from above, and in the present embodiment, the lid 3 covers the entire upper wall 2B from above. The lid 3 can be removed from the housing 2. In a state in which the lid 3 has been removed from the housing 2, the lid 3 opens the cassette compartment 11 upwards, and in the present embodiment, the lid 3 opens the entire upper wall 2B upwards.

The print mechanism 4 is a mechanism for printing on the tape 101 and is housed in the housing 2. The transport mechanism 5 is a mechanism for transporting the tape 101 and is housed in the housing 2. The cutting mechanism 6 is a mechanism for cutting the tape 101 and is housed in the housing 2.

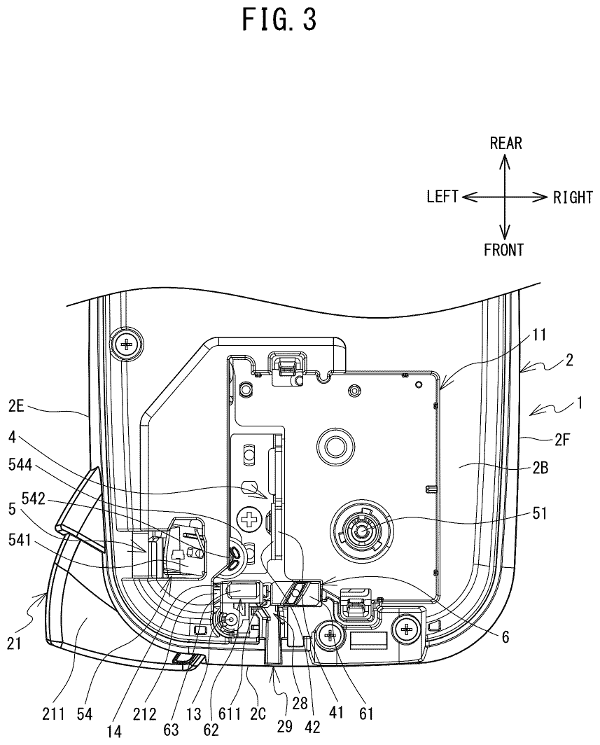

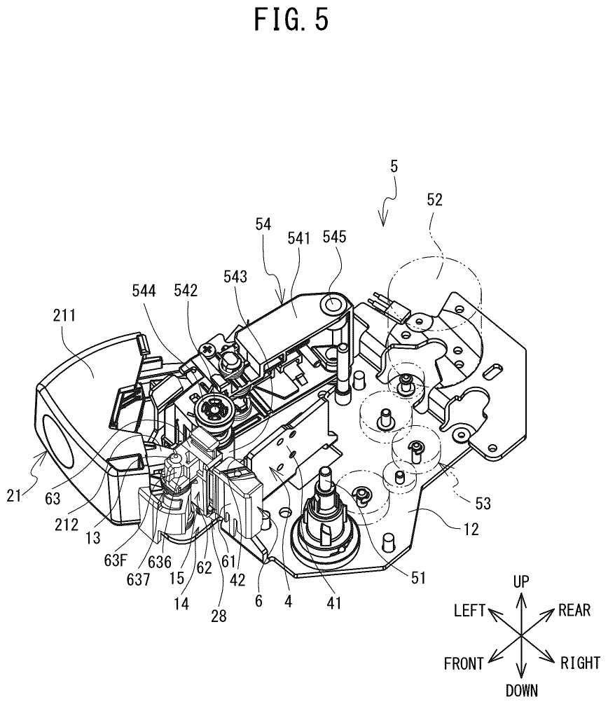

The detailed structure of the print mechanism 4, the transport mechanism 5, and the cutting mechanism 6 will be described with reference to FIG. 3 to FIG. 5. The print mechanism 4, the transport mechanism 5, and the cutting mechanism 6 are supported by the support plate 12 (refer to FIG. 4 and FIG. 5). The support plate 12 extends in the front-rear direction and the left-right direction. The support plate 12 is disposed below the cassette compartment 11 (refer to FIG. 3) in the housing 2 in the space surrounded by the lower wall 2A, the upper wall 2B, the front wall 2C, the rear wall 2D, the left wall 2E, and the right wall 2F, and is fixed to the housing 2.

The print mechanism 4 includes a head holder 41 and a thermal head 42. The head holder 41 is disposed in the left front portion of the cassette compartment 11 (refer to FIG. 3). The head holder 41 has a plate shape and extends in the front-rear direction and the up-down direction. A lower end of the head holder 41 is fixed to the support plate 12 through an opening provided on the bottom surface of the cassette compartment 11 shown in FIG. 3.

The thermal head 42 is fixed to a left surface of the head holder 41. The thermal head 42 has a plate shape and extends in the front-rear direction and the up-down direction. The thermal head 42 includes a plurality of heating elements. The plurality of heating elements are lined up in the up-down direction on a left surface of the thermal head 42. The thermal head 42 selectively heats the plurality of heating elements and performs printing on the tape 101. The head holder 41 serves as a heat sink to allow heat from the plurality of heating elements to escape from the thermal head 42.

The transport mechanism 5 includes a rotation shaft 51, a transport motor 52, a gear train 53, and a platen unit 54. The rotation shaft 51 is disposed to the right of the thermal head 42 in the cassette compartment 11 (refer to FIG. 3) and extends in the up-down direction. A lower end of the rotation shaft 51 is rotatably supported by the support plate 12 through an opening provided on the bottom surface of the cassette compartment 11.

The transport motor 52 is disposed at the rear of the cassette compartment 11 (refer to FIG. 3) and is fixed to the support plate 12. The gear train 53 is rotatably supported by the support plate 12, and connects the transport motor 52 to the rotation shaft 51. Therefore, the driving force of the transport motor 52 is transmitted to the rotation shaft 51 via the gear train 53.

The platen unit 54 is provided with a platen holder 541, a platen shaft 542, a platen roller 543, and a platen gear 544. The platen holder 541 is disposed to the left of the cassette compartment 11 (refer to FIG. 3). The platen holder 541 extends in the front-rear direction and opens to the right. A swing shaft 545 is provided at a rear end of the platen holder 541. The swing shaft 545 extends in the up-down direction and rotatably supports the platen holder 541. A lower end of the swing shaft 545 is fixed to the support plate 12. A front end of the platen holder 541 swings in the left-right direction in a plan view about the swing shaft 545. The front end of the platen holder 541 is urged by a spring (not shown in the drawings) so as to swing to the left about the swing shaft 545.

The platen shaft 542 is rotatably supported by the front end of the platen holder 541 and extends in the up-down direction. The platen roller 543 is disposed at the front end of the platen holder 541 and faces the thermal head 42 from the left. The platen roller 543 has a cylindrical shape and extends in the up-down direction. The platen roller 543 is attached to the lower portion of the platen shaft 542 and is fixed to the platen shaft 542. The platen roller 543 transports the tape 101. The platen gear 544 is disposed at the front end of the platen holder 541 and is positioned above the platen roller 543. The platen gear 544 is attached to the upper end of the platen shaft 542 and is fixed to the platen shaft 542. The platen gear 544 is powered by the output gear 131.

The cutting mechanism 6 includes a cradle 61 and a holder unit 62. The cradle 61 and the holder unit 62 are disposed in front of the thermal head 42 and line up in the left-right direction with the discharge path 28 in between. In the present embodiment, the cradle 61 is disposed to the right with respect to the discharge path 28 and the holder unit 62 is disposed to the left with respect to the discharge path 28. The cradle 61 has a cuboid shape and includes a receiving surface 611 shown in FIG. 4. The receiving surface 611 is provided on the left surface of the cradle 61. The receiving surface 611 extends in a front-rear direction and the up-down direction, and faces to the left. The receiving surface 611 supports the printed tape 101 from the right.

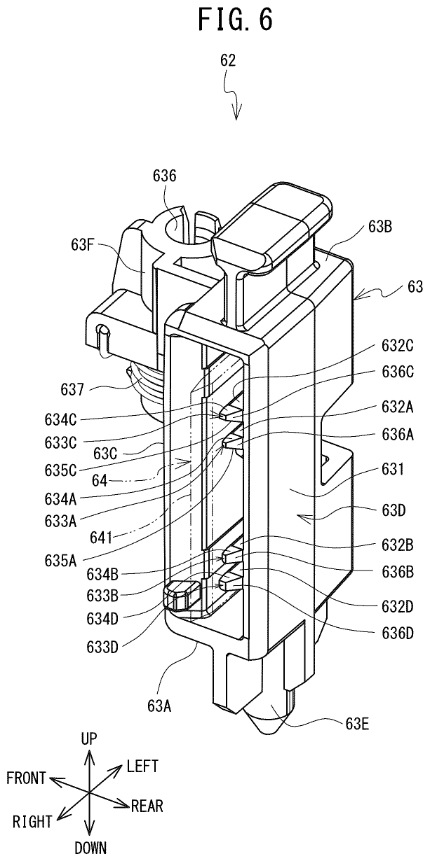

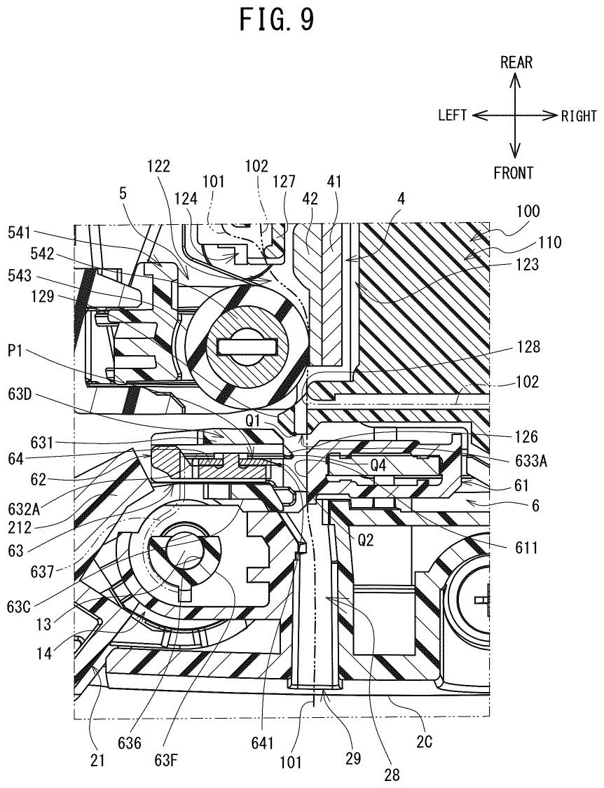

The holder unit 62 will described with reference to FIG. 6 to FIG. 8. As shown in FIG. 6, the holder unit 62 is provided with a cutter blade 64 and the cutter holder 63, and is configured in a state in which the cutter holder 63 holds the cutter blade 64. The cutter blade 64 has a plate shape and extends in the left-right direction and the up-down direction. A cutting edge 641 is formed on the right edge of the cutter blade 64. The cutting edge 641 extends in the up-down direction and faces to the right. The length in the up-down direction at the cutting edge 641 is greater than the maximum width (e.g., 12 mm) in the up-down direction of the tape 101 that can be used with the printer 1. The cutting edge 641 faces the receiving surface 611 with the transport path of the tape 101 in between in the left-right direction (refer to FIG. 9).

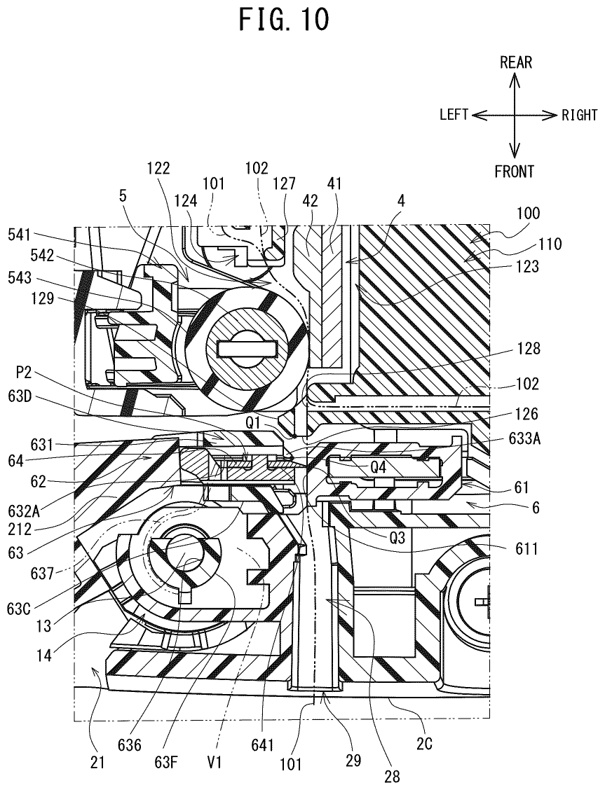

The cutter holder 63 has a box shape and opens to the right and to the left. The cutter holder 63 houses the cutter blade 64 and holds the cutter blade 64 such that the cutter blade 64 can move in the left-right direction between a retracted position P1 (refer to FIG. 9) and a cutting position P2 (refer to FIG. 10), described later.

The cutter holder 63 includes a lower wall 63A, an upper wall 63B, a front wall 63C, a rear wall 63D, a mounting shaft 63E, and a mounting portion 63F. The lower wall 63A extends in the front-rear direction and the left-right direction. The upper wall 63B is aligned above the lower wall 63A and extends in the front-rear direction and the left-right direction. The front wall 63C extends from a front end of the lower wall 63A to a front end of the upper wall 63B. The rear wall 63D extends from a rear end of the lower wall 63A to a rear end of the upper wall 63B. The rear wall 63D is a portion of the cutter holder 63 that is disposed rearward of the cutter blade 64, and includes a plate body 631, a plurality of guide ribs 632A, 632B, 632C, and 632D, and a plurality of protrusions 633A, 633B, 633C, and 633D. The plate body 631 is a plate-shaped portion of the rear wall 63D and extends in the left-right direction and the up-down direction.

The plurality of guide ribs 632A, 632B, 632C, and 632D protrude forward from the front surface of the plate body 631 and extend in the left-right direction. The plurality of guide ribs 632A, 632B, 632C, and 632D are lined up in the order of the guide rib 632C, the guide rib 632A, the guide rib 632B, and the guide rib 632D from up to down. The plurality of guide ribs 632A, 632B, 632C, and 632D each contact the rear surface of the cutter blade 64 and guide the movement of the cutter blade 64 in the left-right direction between the retracted position P1 (refer to FIG. 9) and the cutting position P2 (refer to FIG. 10), described later.

The protrusion 633A is continuous from a right end of the guide rib 632A and protrudes to the right from a right end of the plate body 631. The protrusion 633B is continuous from the right end of the guide rib 632B and protrudes to the right from the right end of the plate body 631. The protrusion 633C is continuous from the right end of the guide rib 632C and protrudes to the right from the right end of the plate body 631. The protrusion 633D is continuous from the right end of the guide rib 632D and protrudes to the right from the right end of the plate body 631. Therefore, the right end of each of the plurality of protrusions 633A, 633B, 633C, and 633D is the right end of the rear wall 63D.

The mounting shaft 63E protrudes downward from the lower wall 63A. The mounting portion 63F protrudes forward from the front wall 63C. A coil spring 637 is wound on a lower end of the mounting portion 63F. One end of the coil spring 637 is hooked to the cutter blade 64. The coil spring 637 urges the cutter blade 64 to the left, that is, from the cutting position P2 (refer to FIG. 10), described later, toward the retracted position P1 (refer to FIG. 9). A mounting hole 636 is formed in the mounting portion 63F. The mounting hole 636 extends upward from a lower surface of the mounting portion 63F, and, in the present embodiment, passes through the mounting portion 63F in the up-down direction.

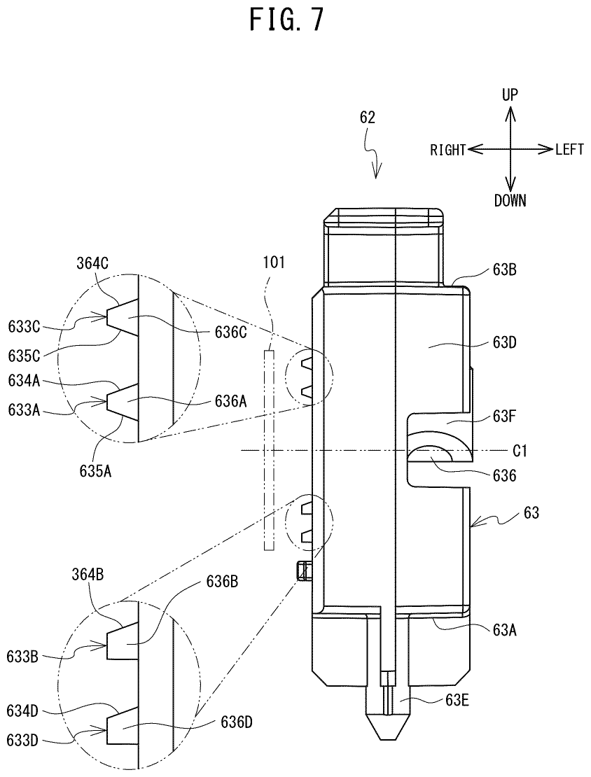

As shown in FIG. 7, in a state in which the cassette 100 is installed in the cassette compartment 11, the center of the tape 101 in the up-down direction will be referred to as a “center C1 in the width direction of the tape 101.” The protrusions 633A and 633C are disposed above the center C1 in the width direction of the tape 101. The protrusion 633C is disposed above the protrusion 633A. The protrusions 633B and 633D are disposed below the center C1 in the width direction of the tape 101. The protrusion 633D is disposed below the protrusion 633B.

In the present embodiment, the distance in the up-down direction from the center C1 in the width direction of the tape 101 to the protrusion 633A and the distance in the up-down direction from the center C1 in the width direction of the tape 101 to the protrusion 633B are the same. The center-to-center distance in the up-down direction in the protrusions 633A and 633B is smaller than the minimum width (e.g., 9 mm) in the up-down direction of the tape 101 that can be used with the printer 1. The distance in the up-down direction from the center C1 in the width direction of the tape 101 to the protrusion 633C and the distance in the up-down direction from the center C1 in the width direction of the tape 101 to the protrusion 633D are the same. The center-to-center distance in the up-down direction in the protrusions 633C and 633D is smaller than the length in the up-down direction at the cutting edge 641 and smaller than the maximum width (e.g., 12 mm) in the up-down direction of the tape 101 that can be used with the printer 1.

A first inclined surface 634A, a second inclined surface 635A, and a third inclined surface 636A are formed on the protrusion 633A. The first inclined surface 634A is provided on an upper surface of the protrusion 633A, extends in the left-right direction, and extends downward towards the right from a left end of the protrusion 633A to a right end of the protrusion 633A. The second inclined surface 635A is provided on a lower surface of the protrusion 633A, extends in the left-right direction, and extends upward towards the right from the left end of the protrusion 633A to the right end of the protrusion 633A. The third inclined surface 636A is provided on a rear surface of the protrusion 633A, extends in the up-down direction, and extends forward towards the right from the left end of the protrusion 633A to the right end of the protrusion 633A (refer to FIG. 6).

A first inclined surface 634B and a third inclined surface 636B are formed on the protrusion 633B. The first inclined surface 634B is provided on an upper surface of the protrusion 633B, extends in the left-right direction, and extends downward towards the right from a left end of the protrusion 633B to a right end of the protrusion 633B. The third inclined surface 636B is provided on a rear surface of the protrusion 633B, extends in the up-down direction, and extends forward towards the right from the left end of the protrusion 633B to the right end of the protrusion 633B (refer to FIG. 6).

A first inclined surface 634C, a second inclined surface 635C, and a third inclined surface 636C are formed on the protrusion 633C. The first inclined surface 634C is provided on an upper surface of the protrusion 633C, extends in the left-right direction, and extends downward toward the right from a left end of the protrusion 633C to a right end of the protrusion 633C. The second inclined surface 635C is provided on a lower surface of the protrusion 633C, extends in the left-right direction, and extends upward toward the right from the left end of the protrusion 633C to the right end of the protrusion 633C. The third inclined surface 636C is provided on a rear surface of the protrusion 633C, extends in the up-down direction, and extends forward towards the right from the left end of the protrusion 633C to the right end of the protrusion 633C (refer to FIG. 6).

A first inclined surface 634D and a third inclined surface 636D are formed in the protrusion 633D. The first inclined surface 634D is provided on an upper surface of the protrusion 633D, extends in the left-right direction, and extends downward toward the right from a left end of the protrusion 633D to a right end of the protrusion 633D. The third inclined surface 636D is provided on a rear surface of the protrusion 633D, extends in the up-down direction, and extends forward towards the right from the left end of the protrusion 633D to the right end of the protrusion 633D (refer to FIG. 6).

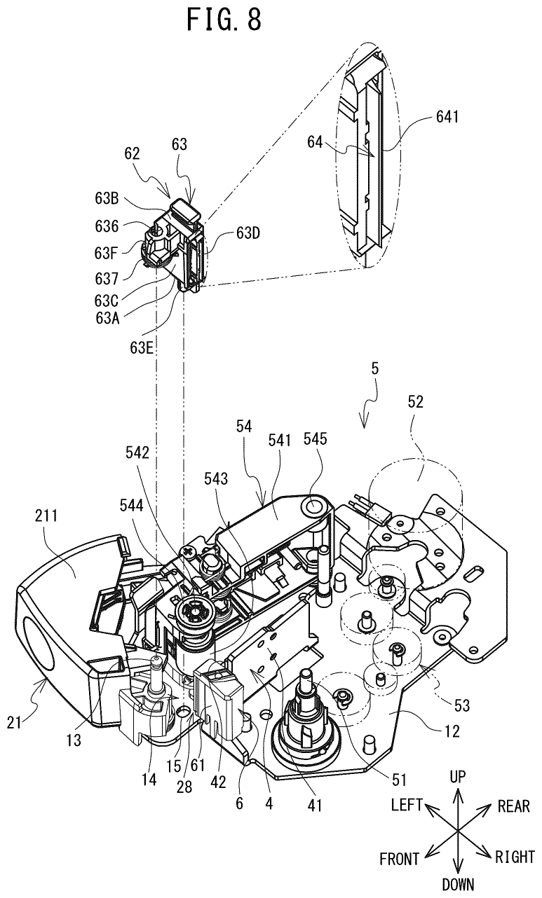

As shown in FIG. 8, in the present embodiment, the holder unit 62 is detachably mounted to the cutter mounting portion 14. The cutter mounting portion 14 is arranged in a position aligned with the cradle 61, with the discharge path 28 between them in the left-right direction. The cutter mounting portion 14 is formed on the upper surface of the support plate 12, and includes the cutter mounting shaft 13 and a cutter mounting hole 15. The cutter mounting hole 15 is disposed in front of the cutter mounting shaft 13 and passes through the support plate 12 in the up-down direction. The user mounts the holder unit 62 from above to the cutter mounting portion 14 and removes the holder unit 62 upward from the cutter mounting portion 14. For example, the user mounts the holder unit 62 to the cutter mounting portion 14 so that the mounting shaft 63E fits into the cutter mounting hole 15 and the cutter mounting shaft 13 fits into the mounting hole 636.

The retracted position P1 and the cutting position P2 will now be described with reference to FIG. 9 and FIG. 10. As shown in FIG. 9, when the cutter blade 64 is positioned at the retracted position P1, the cutting edge 641 is away to the left from the receiving surface 611, and the entire cutter blade 64 is housed in the cutter holder 63. In the present embodiment, when the cutter blade 64 is positioned at the retracted position P1, the cutting edge 641 is disposed to the left of the right end of the plate body 631. The retracted position P1 is a position at the left end of the movement range of the cutter blade 64 in a cutting operation.

As shown in FIG. 10, when the cutter blade 64 is positioned at the cutting position P2, a portion of the cutter blade 64 protrudes from the cutter holder 63 to the right, and the cutting edge 641 contacts the receiving surface 611 from the left. When the cutter blade 64 is positioned at the cutting position P2 while the receiving surface 611 is supporting the tape 101, the cutting edge 641 sandwiches the tape 101 with the receiving surface 611 and cuts the tape 101.

A printing operation and a cutting operation by the printer 1 will now be described with reference to FIG. 1 to FIG. 3, and FIG. 9 to FIG. 11. As shown in FIG. 1, in a state in which the lid 3 has been removed from the housing 2, the user installs the cassette 100 from above down into the cassette compartment 11 so that the rotation shaft 51 fits into the support hole 111 shown in FIG. 2 and the print mechanism 4 fits into the recessed portion 123 shown in FIG. 2. The user attaches the lid 3 to the housing 2. Consequently, as shown in FIG. 11, the front end of the platen holder 541 swings from a position (refer to FIG. 3) urged to the left by the spring (not shown in the drawings) to the right about the swing shaft 545 via a cam (not shown in the drawings). In this case, the platen roller 543 presses the ink ribbon 102 and the tape 101 against the thermal head 42 from the left in a state in which the ink ribbon 102 and the tape 101 are overlaid with each other. Further, the platen gear 544 engages with the output gear 131.

The user inputs a printing instruction to the printer 1 via the operation portion (not shown in the drawings). The printer 1 drives the transport motor 52 shown in FIG. 4. As a result, the rotation shaft 51 shown in FIG. 3 causes the ribbon winding spool 130 shown in FIG. 2 and the input gear (not shown in the drawings) to rotate. As shown in FIG. 9, the rotation of the ribbon winding spool 130 shown in FIG. 2 causes the ink ribbon 102 to be transported so that it enters the cassette case 110 from the entrance 128. The rotation of the input gear causes the output gear 131 shown in FIG. 11 to rotate via a connecting gear (not shown in the drawings). The rotation of the output gear 131 causes the platen gear 544 shown in FIG. 11 to rotate, which in turn causes the platen roller 543 to rotate.

The rotation of the platen roller 543 in the clockwise direction in a plan view causes the tape 101 sandwiched between the platen roller 543 and the thermal head 42 to be transported forward. Therefore, the rear of the printer 1 is upstream in the transport direction of the tape 101, and the front of the printer 1 is downstream in the transport direction of the tape 101. The thermal head 42 selectively heats the plurality of heating elements. This causes the ink of the ink ribbon 102 to be thermally transferred to the tape 101 at a position corresponding to the heated heating elements. The printer 1 prints to the tape 101 by repeating the transport of the tape 101 by the platen roller 543 and the selective heating of the plurality of heating elements by the thermal head 42.

The tape 101 printed at the exposed portion 122 is discharged from the cassette case 110 through the discharge port 126. When the tape 101 is discharged from the cassette case 110, the tape 101 passes through the discharge path 28 and is discharged from the discharge port 29.

As shown in FIG. 10, when printing is finished, the user pushes the operation portion 211 toward the rear with the cutting lever 21. As a result, the contact portion 212 swings to the right about the cutter mounting shaft 13. The contact portion 212 contacts the left end of the cutter blade 64 and pushes the cutter blade 64 from left to right. Accordingly, the cutter blade 64 moves to the right, and moves from the retracted position P1 shown in FIG. 9 to the cutting position P2 shown in FIG. 10.

In the discharge path 28, the receiving surface 611 supports the tape 101 from the right. Therefore, the cutter blade 64 moves from the retracted position P1 to the cutting position P2 so that the tape 101 is pushed from left to right against the receiving surface 611 by the cutting edge 641. The tape 101 is cut by the cutter blade 64. The user lets go of the cutting lever 21. The urging force of the coil spring 637 causes the cutter blade 64 to move from the cutting position P2 shown in FIG. 10 to the retracted position P1 shown in FIG. 9, and the cutting lever 21 to return to its original position.

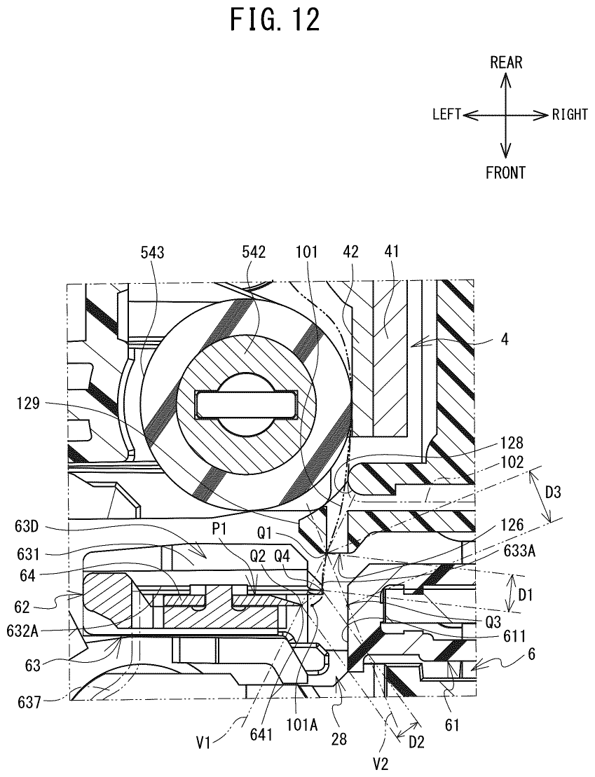

The positional relationship of the protrusion 633A will now be described with reference to FIG. 12. The protrusion 633A is disposed forward of the discharge port 126. The protrusion 633A is disposed rearward of the cutter blade 64. Virtual straight lines V1 and V2 will be defined. The virtual straight line V1 is a virtual straight line connecting a point Q1 and a point Q2. In the present embodiment, the virtual straight line V1 extends toward the left as it extends forward. The virtual straight line V2 is a virtual straight line connecting the point Q1 and a point Q3. In the present embodiment, the virtual straight line V2 extends toward the right as it extends forward.

The point Q1 indicates a left end position of the discharge port 126 in a state in which the cassette 100 is installed in the cassette compartment 11. The point Q2 indicates a position of the cutting edge 641 in a state in which the cutter blade 64 is disposed at the retracted position P1. The point Q3 indicates a position of the cutting edge 641 in a state in which the cutter blade 64 is disposed at the cutting position P2 (refer to FIG. 10). A point Q4 indicates the right end position of the protrusion 633A.

The point Q4 (right end of the protrusion 633A) is disposed to the right of the virtual straight line V1 and to the left of the virtual straight line V2. The sum of a distance D1 between the point Q1 and the point Q4 and a distance D2 between the point Q4 and the point Q2 is less than a distance D3 between the point Q1 and the point Q3. The distance D2 between the point Q4 and the point Q2 is less than the distance DI between the point Q1 and the point Q4.

The position of right ends of the plurality of protrusions 633B, 633C, and 633D in the left-right direction is the same as the position of the right end of the protrusion 633A (the point Q4) in the left-right direction, and the position of the right ends of the plurality of protrusions 633B, 633C, and 633D in the front-rear direction is the same as the position of the right end of the protrusion 633A (the point Q4) in the front-rear direction. Accordingly, like the right end of the protrusion 633A, the right end of each of the protrusions 633B, 633C, and 633D is also disposed to the right of the virtual straight line V1 shown in FIG. 9, and disposed to the left of the virtual straight line V2 shown in FIG. 10.

The main operation and effect of the above embodiment will now be described. As shown in FIG. 12, in the above embodiment, when the tape 101 is cut by the cutting mechanism 6, there is a possibility that the cutter blade 64 will move from the cutting position P2 toward the retracted position P1 with a tip end 101A of the tape 101 stuck to the cutting edge 641.

In the above embodiment, the right end of the rear wall 63D is disposed to the right of the virtual straight line V1. Consequently, the sum of the distance D1 between the point Q1 and the point Q4 and the distance D2 between the point Q4 and the point Q2 is less than the distance D3 between the point Q1 and point Q3. Therefore, while the cutter blade 64 is moving from the cutting position P2 to the retracted position P1, the tape 101 contacts the right end of the rear wall 63D, so the tape 101 will easily come free from the cutting edge 641 (refer to FIG. 12). Therefore, starting of the next printing by the printer 1 while the tip end 101A of the tape 101 is stuck to the cutting edge 641 is suppressed. Thus, the printer 1 contributes to suppressing the occurrence of a jam. Further, the printer 1 contributes to a reduction in the number of parts, a reduction in the size of the housing 2, and a reduction in the weight of the housing 2, and the like compared to a case in which a member other than the cutter holder 63 contacts the tape 101 to suppress the occurrence of a jam.

When the right end of the rear wall 63D has a planar shape, the contact area between the tape 101 and the right end of the rear wall 63D will be large, so there is a possibility that the tape 101 will be damaged. In the above embodiment, the right end of each of the plurality of protrusions 633A, 633B, 633C, and 633D is the right end of the rear wall 63D. Therefore, an increase in the contact area between the tape 101 and the right edge of the rear wall 63D is suppressed. Thus, the printer 1 contributes to suppressing damage to the tape 101.

In the above embodiment, the protrusion 633A is disposed above the center C1 in the width direction of the tape 101. The protrusion 633B is disposed below with the center C1 in the width direction of the tape 101. Accordingly, in the up-down direction, the tape 101 contacts the protrusions 633A and 633B on both sides of the center C1 in the width direction of the tape 101. As a result, the tape 101 will come free from the cutting edge 641 more easily than when the tape 101 contacts the protrusions 633A and 633B on one side of the center C1 in the width direction of the tape 101 in the up-down direction. Therefore, starting of the next printing by the printer 1 with the tip end 101A of the tape 101 stuck to the cutting edge 641 is further suppressed. Thus, the printer 1 contributes to further suppressing the occurrence of a jam.

In the above embodiment, the protrusion 633C is disposed above the protrusion 633A, and the protrusion 633D is disposed below the protrusion 633B. Accordingly, the area near both ends of the tape 101 contacts the protrusions 633C and 633D, and the area near the center of the tape 101 contacts the protrusions 633A and 633B on both sides, in the up-down direction, of the center C1 in the width direction of the tape 101. This ensures that the tape 101 will come free from the cutting edge 641. Therefore, starting of the next printing by the printer 1 with the tip end 101A of the tape 101 stuck to the cutting edge 641 is further suppressed. Thus, the printer 1 contributes to further suppressing the occurrence of a jam.

In the above embodiment, the protrusions 633A, 633B, 633C, and 633D are provided with the first inclined surfaces 634A, 634B, 634C, and 634D, respectively. Accordingly, even if the tape 101 were to contact the protrusion 633A, for example, while the cassette 100 is being installed in the cassette compartment 11, the tape 101 is guided downward along the first inclined surface 634A, that is, along the direction in which the cassette 100 is installed in the cassette compartment 11. Therefore, the printer 1 contributes to suppressing the tape 101 from getting caught on the protrusions 633A, 633B, 633C, and 633D and being damaged when the cassette 100 is installed in the cassette compartment 11.

In the above embodiment, the second inclined surfaces 635A and 635C are provided on the protrusions 633A and 633C, respectively. Accordingly, even if the tape 101 were to contact the protrusion 633A, for example, while the cassette 100 is being removed from the cassette compartment 11, the tape 101 is guided upward along the second inclined surface 635A, that is, along the direction in which the cassette 100 is removed from the cassette compartment 11. Therefore, the printer 1 contributes to suppressing the tape 101 from getting caught on the protrusions 633A and 633C and being damaged when the cassette 100 is removed from the cassette compartment 11.

The smaller the distance D2 between the points Q4 and the point Q2, the greater the rigidity acting on the front end of the tape 101 when the tape 101 contacts the protrusions 633A, 633B, 633C, and 633D. In the above embodiment, the guide ribs 632A, 632B, 632C, and 632D protrude forward from the plate body 631. The guide ribs 632A, 632B, 632C, and 632D contact the rear surface of the cutter blade 64 and guide the movement of the cutter blade 64 to the retracted position P1 and the cutting position P2. The protrusions 633A, 633B, 633C, and 633D continue on from the right ends of the guide ribs 632A, 632B, 632C, and 632D, respectively, and protrude to the right. Accordingly, since the guide ribs 632A, 632B, 632C, and 632D contact the rear surface of the cutter blade 64, the protrusions 633A, 633B, 633C, and 633D are disposed at positions close to the cutter blade 64 in the front-rear direction. In other words, the distance D2 between the point Q4 and the point Q2 becomes smaller, and the rigidity acting on the front end of the tape 101 becomes larger when the tape 101 contacts the protrusions 633A, 633B, 633C, and 633D. Therefore, the tape 101 is more likely to come free from the cutting edge 641. Therefore, the printer 1 contributes to further suppressing the occurrence of a jam.

In the above embodiment, the cutter holder 63 is detachably mounted to the cutter mounting portion 14 while the cutter holder 63 holds the cutter blade 64. Accordingly, even if the adhesive of the tape 101 sticks to the protrusions 633A, 633B, 633C, and 633D, the user can remove the cutter holder 63 from the cutter mounting portion 14 and mount a cleaned cutter holder 63 or a new cutter holder 63 to the cutter mounting portion 14. Therefore, starting the next printing by the printer 1 with the tape 101 stuck to the protrusions 633A, 633B, 633C, and 633D is suppressed. Therefore, the printer 1 contributes to suppressing the occurrence of a jam.

In the above embodiment, the third inclined surfaces 636A, 636B, 636C, and 636D are provided on the protrusions 633A, 633B, 633C, and 633D, respectively. Accordingly, even if, for example, the tip end 101A of the tape 101 hits on the protrusion 633A during transport of the tape 101, the tape 101 is guided forward along the third inclined surface 636A, that is, downstream in the transport direction. Therefore, the printer 1 contributes to suppressing the tape 101 from getting caught on the protrusions 633A, 633B, 633C, and 633D during the transport of the tape 101 and causing a jam.

In the above embodiment, the tape 101 is one example of the “medium” of the present disclosure. The cassette case 110 is one example of the “cassette case” of the present disclosure. The cassette 100 is one example of the “cassette” of the present disclosure. The cassette compartment 11 is one example of the “cassette compartment” of the present disclosure. The platen roller 543 is one example of the “transport roller” of the present disclosure. The thermal head 42 is one example of the “print head” of the present disclosure. The cradle 61 is one example of the “cradle” of the present disclosure. The up-down direction of the printer 1 is one example of the “intersecting direction” of the present disclosure. The cutting edge 641 is one example of the “cutting edge” of the present disclosure. The left-right direction of the printer 1 is one example of the “facing direction” of the present disclosure. The cutter blade 64 is one example of the “cutter blade” of the present disclosure. The cutter holder 63 is one example of the “cutter holder” of the present disclosure. The rear wall 63D is one example of the “specific wall” of the present disclosure. The discharge port 126 is one example of the “discharge port” of the present disclosure. The left of the printer 1 is one example of the “first facing direction” of the present disclosure. The virtual straight line V1 is one example of the “virtual straight line” of the present disclosure. The right of the printer 1 is one example of the “second facing direction” of the present disclosure.

The plate body 631 is one example of the “plate body” of the present disclosure. The protrusion 633A is one example of the “first protrusion” of the present disclosure. The protrusion 633B is one example of the “second protrusion” of the present disclosure. Upward with respect to the printer 1 is one example of the “first intersecting direction” of the present disclosure. Downward with respect to the printer 1 is one example of the “second intersecting direction” of the present disclosure. The protrusion 633C is one example of the “third protrusion” of the present disclosure. The protrusion 633D is one example of the “fourth protrusion” of the present disclosure. The first inclined surfaces 634A, 634B, 634C, and 634D are examples of the “first inclined surface” of the present disclosure. The second inclined surfaces 635A and 635C are examples of the “second inclined surface” of the present disclosure. The guide ribs 632A, 632B, 632C, and 632D are examples of the “guide rib” of the present disclosure. The cutter mounting portion 14 is one example of the “cutter mounting portion” of the present disclosure.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described disclosure are provided below:

With regards to modified examples relating to the plurality of protrusions 633A, 633B, 633C, and 633D, only a modified example relating to the protrusion 633A will be illustrated as an example. In this case, the protrusions 633B, 633C, and 633D may also be modified in the same manner as the protrusions 633A.

In the above embodiment, the holder unit 62 may be non-detachably mounted to the cutter mounting portion 14. Some or all of the plurality of guide ribs 632A, 632B, 632C, and 632D may be omitted. For example, when the guide rib 632A is omitted, the protrusion 633A may protrude to the right from the right end of the plate body 631.

In the above embodiment, the second inclined surface 635A need not be provided on the lower surface of the protrusion 633A. In this case, the lower surface of the protrusion 633A may extend orthogonal to the up-down direction, for example. The first inclined surface 634A need not be provided on the upper surface of the protrusion 633A. In this case, the upper surface of the protrusion 633A may extend orthogonal to the up-down direction, for example. The third inclined surface 636A need not be provided on the rear surface of the protrusion 633A. In this case, the rear surface of the protrusion 633A may extend orthogonal to the front-rear direction, for example.

In the above embodiment, one of the plurality of protrusions 633A and 633C may be omitted, and one of the plurality of protrusions 633B and 633D may be omitted. One pair of pair of the plurality of protrusions 633A and 633C and the pair of the plurality of protrusions 633B and 633D may be omitted.

The rear wall 63D may omit some or all of the plurality of protrusions 633A, 633B, 633C, and 633D. For example, when all of the plurality of protrusions 633A, 633B, 633C, and 633D are omitted, the right end of the plate body 631 is the right end of the rear wall 63D. In this case, the right end of the plate body 631 may be disposed at least to the right of the virtual straight line V1. The rear wall 63D may further have protrusions in addition to the plurality of protrusions 633A, 633B, 633C, and 633D. For example, the plate body 631 may be provided with a protrusion at the same position as the center C1 in the width direction of the tape 101 in the up-down direction.

The cassette 100 may be provided with a tube in place of the tape 101. The cassette 100 may omit the ink ribbon 102. In this case, the tape 101 may be made of thermal paper. The thermal head 42 may be disposed to the left of the cassette compartment 11, and the platen roller 543 may be disposed in the cassette compartment 11 so as to be inserted into the recessed portion 123.

The cradle 61 may be disposed to the left of the discharge path 28 and the holder unit 62 may be disposed to the right of the discharge path 28. The printer 1 may include a shaft for swinging the cutter blade 64 between the retracted position P1 and the cutting position P2. The printer 1 may include a motor for moving the cutter blade 64 to the retracted position P1 and the cutting position P2.

The sum of the distance D1 between the point Q1 and the point Q4 and the distance D2 between the point Q4 and the point Q2 may be the same as the distance D3 between the point Q1 and the point Q3 or may be less than the distance D3 between the point Q1 and the point Q3. The distance D2 between the point Q4 and the point Q2 may be the same as the distance D1 between the point Q1 and the point Q4, or may be greater than the distance D1 between the point Q1 and the point Q4.

The right end (the point Q4) of the protrusion 633A may be disposed at the same position as the virtual straight line V2 in the left-right direction, or may be disposed to the right of the virtual straight line V2. The position of the right ends of the plurality of protrusions 633B, 633C, and 633D in the left-right direction may be different from the position of the right end of the protrusion 633A (the point Q4). The position of right end of the plurality of protrusions 633B, 633C, and 633D in the front-rear direction may be different from the position of the right end of the protrusion 633A (the point Q4).

What is claimed is:

1. A printer which uses a cassette provided with a medium and a cassette case configured to house the medium, comprising:
a cassette compartment in which the cassette is removably installed;
a transport roller configured to transport the medium;
a print head configured to print on the medium;
a cradle disposed downstream of the print head in a transport direction of the medium, and configured to support the medium;
a cutter blade that is a plate on which is formed a cutting edge extending in an intersecting direction intersecting the transport direction, the cutting edge facing the cradle in a facing direction intersecting the transport direction and the intersecting direction; and
a cutter holder that holds the cutter blade and configured to move the cutter blade between a retracted position and a cutting position, the cutting edge being separated from the cradle in the facing direction when the cutter blade is positioned at the retracted position, and the cutting edge sandwiching the medium with the cradle and cutting the medium when the cutter blade is positioned at the cutting position, the cutter holder including a specific wall disposed upstream of the cutter blade in the transport direction,
wherein in a state in which the cassette is installed in the cassette compartment and the cutter blade is disposed at the retracted position, when a virtual straight line is defined that connects the cutting edge and an end, in a first facing direction from the cradle toward the cutter blade, in the facing direction, of a discharge port, which is an opening formed at a downstream end of the cassette case in the transport direction, through which the medium is discharged from the cassette case, an end of the specific wall in a second facing direction opposite the first facing direction, in the facing direction, is disposed to the second facing direction of the virtual straight line.

2. The printer according to claim 1, wherein
the specific wall includes
a plate body extending in the intersecting direction and the facing direction, and
a first protrusion protruding to the second facing direction of the end in the second facing direction of the plate body, and
the end in the second facing direction of the first protrusion is an end in the second facing direction of the specific wall.

3. The printer according to claim 2, wherein
the specific wall further includes a second protrusion protruding to the second facing direction from the plate body,
the cassette compartment is configured such that the cassette is installed in the cassette compartment from a first intersecting direction, in the intersecting direction, toward a second intersecting direction opposite the first intersecting direction,
the first protrusion is disposed in the first intersecting direction with respect to a center of the medium, in the intersecting direction, in a state in which the cassette is installed in the cassette compartment, and
the second protrusion is disposed in the second intersecting direction with respect to the center of the medium, in the intersecting direction, in a state in which the cassette is installed in the cassette compartment.

4. The printer according to claim 3, wherein
the specific wall further includes
a third protrusion protruding in the second facing direction from the plate body, and
a fourth protrusion protruding in the second facing direction from the plate body,
the third protrusion being disposed in the first intersecting direction with respect to the first protrusion, and
the fourth protrusion being disposed in the second intersecting direction with respect to the second protrusion.

5. The printer according to claim 2, wherein
the cassette compartment is configured such that the cassette is installed in the cassette compartment from a first intersecting direction, in the intersecting direction, toward a second intersecting direction opposite the first intersecting direction, and
a first inclined surface extending in the second intersecting direction as the first inclined surface extends in the second facing direction is provided on a surface of the first protrusion in the first intersecting direction.

6. The printer according to claim 2, wherein
the cassette compartment is configured such that the cassette is installed in the cassette compartment from a first intersecting direction, in the intersecting direction, toward a second intersecting direction opposite the first intersecting direction,
the first protrusion is disposed in the first intersecting direction with respect to a center of the medium, in the intersecting direction, in a state in which the cassette is installed in the cassette compartment, and
a second inclined surface extending in the first intersecting direction as the second inclined surface extends in the second facing direction is provided on a surface of the first protrusion in the second intersecting direction.

7. The printer according to claim 2, wherein
the specific wall further includes a guide rib protruding downstream from the plate body in the transport direction, and contacting an upstream-facing side surface of the cutter blade, and configured to guide movement of the cutter blade to the retracted position and the cutting position, and
the first protrusion continues from an end, in the second facing direction, of the guide rib and protrudes in the second facing direction.

8. The printer according to claim 1, further comprising:
a cutter mounting portion to which the cutter holder is detachably mounted while the cutter holder is holding the cutter blade is provided.

9. The printer according to claim 2, further comprising:
a cutter mounting portion to which the cutter holder is detachably mounted while the cutter holder is holding the cutter blade is provided.

10. The printer according to claim 3, further comprising:
a cutter mounting portion to which the cutter holder is detachably mounted while the cutter holder is holding the cutter blade is provided.

11. The printer according to claim 4, further comprising:
a cutter mounting portion to which the cutter holder is detachably mounted while the cutter holder is holding the cutter blade is provided.

12. The printer according to claim 5, further comprising:
a cutter mounting portion to which the cutter holder is detachably mounted while the cutter holder is holding the cutter blade is provided.

13. The printer according to claim 6, further comprising:
a cutter mounting portion to which the cutter holder is detachably mounted while the cutter holder is holding the cutter blade is provided.

14. The printer according to claim 7, further comprising:
a cutter mounting portion to which the cutter holder is detachably mounted while the cutter holder is holding the cutter blade is provided.
